(19) United States
(12) Patent Application Publication
(10) Pub. No.: US 2008/0307794 A1
(43) Pub. Date: Dec. 18, 2008

(54) GUANIDINE BASED FUEL SYSTEM AND METHOD OF OPERATING A COMBUSTION SYSTEM

(76) Inventors: Robert Kurt Graupner, Hillsboro, OR (US); James Aldon Van Vechten, Corvallis, OR (US); J. Dustin Hultine, Portland, OR (US)

Correspondence Address: Robert Kurt Graupner, 21465 NW Coffey Lane, Hillsboro, OR, 97124-8173, US

(21) Appl. No.: 11/764,063

(22) Filed: Jun. 15, 2007

(51) Int. Cl. F02B 43/10; F02C 3/22

(52) U.S. Cl. 60/780; 60/736; 123/3

(57) ABSTRACT

A guanidine based fuel delivery system and method of powering a combustion engine or furnace may be operable to supplying a guanidine-based composition consisting substantially of water, ethanol and guanidine into a reactor chamber. Guanidine and water of the guanidine-based composition may react in the reactor chamber to produce ammonia and carbon dioxide. The products from the reactor chamber may be delivered to a combustion chamber of the combustion based energy conversion system and combusted therein. A controller may control the injecting of product from the reacted composition into the combustion chamber according to at least one attribute of the group consisting of: a level of power predetermined for desired operation of the combustion based energy conversion system, a performance parameter of the combustion based energy conversion system determined during operation thereof, and a concentration determined for at least one of the reactants/products in the reactor chamber and the reactants/products from the combustion chamber.

### RELATED DATA

This non-provisional application claims priority and benefit of U.S. Provisional Application Ser. No. 60/813,388 filed Jun. 14, 2006, and U.S. Provisional Application Ser. No. 60/903,439 filed Feb. 25, 2007, each of which are hereby incorporated by reference in their entirety.

### TECHNOLOGICAL FIELD

The present disclosure relates to “alternative fuels,” and more particularly to the use of guanidine-based fuels in operating combustion engines and furnaces.

### BACKGROUND

Fossil fuels are generally known to be produced in large quantities today with common acceptance in view of its recognized high energy density and present availability and acceptable cost of production. Accordingly, diesel and/or gasoline fuels have been commonly employed as the fuels of choice for various engine applications. However, given that the availability of fossil fuels may diminish, a portion of the industry has more recently begun to explore alternative fuels.

Hydrogen has received some attention as an alternative fuel. Various representatives of the industry, however, have suggested that neither compressed gaseous hydrogen nor its liquefied elemental form may likely be deemed sufficiently economical, practical and safe for offering hope as a viable alternative fuel.

Carbon chemistry based approaches for alternative fuels have likewise been receiving some attention in applications for diesel and spark-ignition engines. For example, “bio-diesel fuels” may be known as an alternative fuel for diesel engines that is usually derived from various vegetable oils treated with ethanol or methanol. For spark-ignition engines, on the other hand, ethanol and methanol may be recognized more directly as the alternative fuels. These various carbon chemistry based alternative fuels may also be know for powering other forms of combustion engines such as turbines. While offering a possible alternative, the carbon chemistry based alternative fuels, however, has been critiqued due to various considerations, which include for example the viability of their supplies, which could ultimately depend on surplus of agricultural and organic waste. Further, the production costs of such carbon chemistry based alternative fuels may also affect its acceptance as a viable alternative fuel.

Ammonia (NH₃) may be known as yet another type of alternative fuel that is nitrogen-based. As may be recognized, at least herein by way of this disclosure, it can offer an energy density of about 5.0 kWhr/kg for the fuel alone, which is greater than the incentive target of 3.0 kWhr/kg (total storage system) recently proposed to the industry for the year 2015. Ammonia may be liquefied at modest pressure (−10 atmospheres) and in an ambient temperature for a density of about 0.65 kg/l, which in turn may be further quantified for a volume energy density of about 3.25 kWhr/l (i.e., for the fuel alone). Storage containers may be readily available for storage of the ammonia for its integration with vehicles of combustion engines.

When using ammonia for powering combustion systems, a low flame propagation velocity of the ammonia relative to that of conventional fuels may require some design consideration. Some within the industry may simply limit use of ammonia fuels to applications capable of accommodating the low flame velocity. For example, it may be employed in slow internal combustion engine applications or in alternative turbine applications. As recognized herein, therefor, the rate of fuel burn for such applications is not as stringent as may otherwise be required for fast internal combustion engines, wherein the fuel may be expected to burn before a piston travels down the cylinder. In the context of turbines, however, it may be understood that the fuel burn simply serves to provide and maintain a pressure within a given pressure vessel from which gasses may operatively flow to spin a turbine. Accordingly, a fuel-air mixture for combustion may have a relatively long period of time for reaction before having to exit and spin the turbine.

Others may choose instead to enhance the combustion or rate of flame velocity of the ammonia. In a particular example, a portion of the ammonia may be cracked to form hydrogen and nitrogen. The hydrogen may then be used to accelerate flame propagation of the remaining ammonia composition. Where the hydrogen remains mixed with the remaining ammonia, it will serve to accelerate the flame propagation in the mixture given that the flame propagation of hydrogen is quite fast so as to ignite the surrounding ammonia. In another case, the hydrogen may be separated from the ammonia, e.g., by means of a semi-permeable membrane. Subsequently, the extracted hydrogen may be injected into a combustion chamber when a piston is near its top-dead-center position wherein the ammonia is compressed together with the air. Upon injection, the hydrogen can assist ignition, which may be effected by either the compression itself (as a “diesel mode”) or by spark (as a “gasoline mode”) depending upon the compression ratio operability of the internal combustion engine.

One draw-back to ammonia fuel systems, however, concerns the highly toxic nature of ammonia. Anhydrous ammonia is an extremely toxic substance. As a gas, its immediate danger to health and life, IDHL, threshold is merely 500 parts per million by volume in ambient air. Assuming a density of ambient air of approximately 1 kg/m³ and a molecular weight for ammonia of 17 compared to more than 28 for the air, each kilogram of ammonia that escapes from a storage tank could render more than 3200 m³ of air uninhabitable. A quantity of ammonia sufficient to fuel an automobile or a truck, say for example an equivalent to 60 gallons of gasoline, might require storing more than 342 kg ammonia. Accidental rapture of an ammonia fuel storage tank of such size could, thus, produce a lethal and slowly rising cloud tilling as much as 1,000,000 m³ of air.

Urea has also been proposed as another possible alternative fuel. It may be known as a relatively safe material for the storage of ammonia. The ammonium may be subsequently released from the urea by way of reaction (1) below:

CO(NH₂)₂+H₂O→2NH₃+CO₂ (1)

The energy density of aqueous forms of urea solution may generally be understood below the density of that for pure solid urea which is about 1.34 kg/l. Accordingly, the energy density per unit volume of such urea-based fuel may be understood to fall below volumetric energy density targets as proposed for the industry and market.

Guanidine has been proposed as yet another type of nitrogen-based alternative fuel. See International Publication No. WO 2005/108289 A2 published Nov. 17, 2005 (from International Appl. No, PCT/US2005/015920, filed May 3, 2005). Such guanidine based alternative has been recognized with a capability of reducing overall emissions of greenhouse gases. It may also be recognized with the possibility of alleviating some other concerns associated with fossil fuels, such as various problems and risks associated with the extraction and delivery of fossil fuels. For example, the conventional fuels are known to pose possible carcinogenic risks. Accordingly, they have often required expensive procedures for clean-up when spilled, Guanidine, on the other hand, may be characterized in liking with a fertilizer, if accidentally spilled, therefore, it may be readily addressed by a procedure that may be as simple as washing it away with water.

### SUMMARY

According to an embodiment of the invention, a guanidine based fuel delivery system and method of powering a combustion engine or furnace may be operable to supplying a guanidine-based composition consisting substantially of water, ethanol and guanidine into a reactor chamber. Guanidine and water of the guanidine-based composition may react in the reactor chamber to produce ammonia and carbon dioxide. The products from the reactor chamber may be delivered to a combustion chamber of the combustion based energy conversion system and combusted therein. A controller may control the injecting of product from the reacted composition into the combustion chamber according to at least one attribute of the group consisting of: a level of power predetermined for desired operation of the combustion based energy conversion system, a performance parameter of the combustion based energy conversion system determined during operation thereof, and a concentration determined for at least one of the reactants/products in the reactor chamber and the reactants/products from the combustion chamber.

According to another embodiment, a method of energy conversion may comprise supplying a composition comprising guanidinium borohydride and reacting the composition with water and forming hydrogen, ammonia, carbon dioxide and boric acid. At least a portion of the ammonia and hydrogen resulting from the reaction may then be oxidized for releasing energy, while forming water and nitrogen.

In another embodiment, a fueling system may comprise a mixture container to receive guanidine from a guanidine source and ethanol from an ethanol source. First and second metering devices may be variably operable by electrical signaling to meter guanidine from the guanidine source and ethanol from the ethanol source respectively to the mixture container. A controller may be operable to determine a concentration of the ethanol in the ethanol source and to affect at least one of first and second control signals to the first and second metering devices respectively for establishing a ratio of the guanidine to ethanol delivery to the mixture container based on the concentration of ethanol determined.

In yet a further embodiment, an engine control system may comprise an analysis module operable to analyze the composition of a guanidine/ethanol based fuel that is to power an engine, and a control driver operable to adjust at least one of the engine parameters based on the analysis to affect the efficiency for the fuel burn in the engine.

### BRIEF DESCRIPTION OF DRAWINGS

Subject matter for embodiments of the present invention may be further understood by reference to the following detailed description when read with reference to the accompanying drawings, in which:

FIG. 1 is a simplified schematic diagram for an embodiment of the invention showing a guanidine based combustion system as may be used for also explaining an associated method of operation.

FIG. 2 is a simplified schematic diagram for another embodiment of the invention showing another guanidine based combustion system that also may be used to assist understanding of a further method of operation.

FIG. 3 is a simplified schematic diagram for a reactor that may be used in various embodiments of the invention.

FIG. 4 is a simplified schematic diagram for a fuel delivery system in accordance with another embodiment of the invention.

### DESCRIPTION

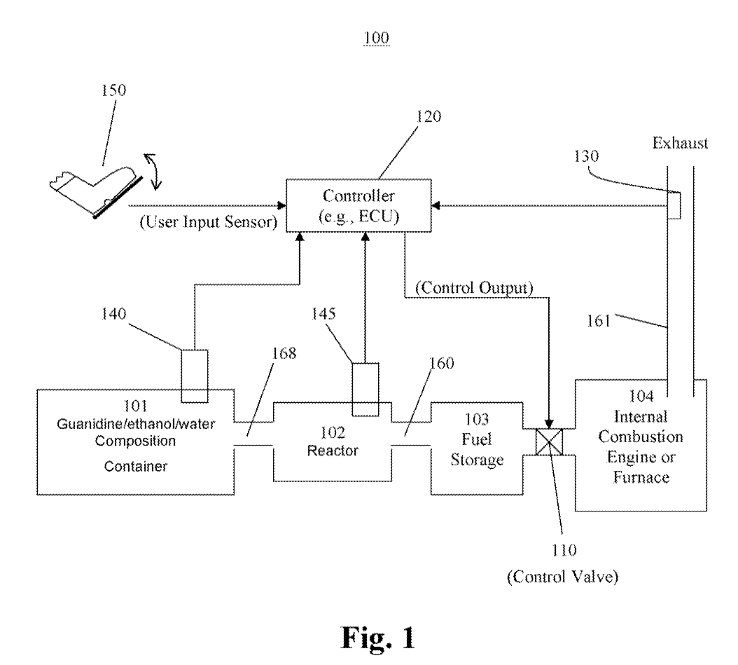

In accordance with an embodiment of the present invention, referencing FIG. 1, combustion based energy conversion system 100 may be representative of combustion engine or furnace. In one example, an internal combustion engine as combustion based energy conversion system 100 may comprise fuel container 101 operable to supply a guanidine-based composition. In a particular example, the fuel container may supply a guanidine-based composition consisting substantially of guanidine, ethanol and water.

Further referencing FIG. 1, delivering means 168 may be operatively coupled between fuel container 101 and reactor 102 for delivery of fuel to the reactor. In a particular example, the liquid delivery means may include a selectively operable pump and/or check valve be selectively operable based upon a determined level of reactants in reactor 102 and/or a determined amount of product from the reacted composition present in the reserve of storage 103. Accordingly, when a reserve of product in storage 103 and/or that of the reactants in reactor 102 should fall below a certain level, the pump in liquid delivery means 168 may be activated to deliver additional guanidine/ethanol/water fuel to the reactor.

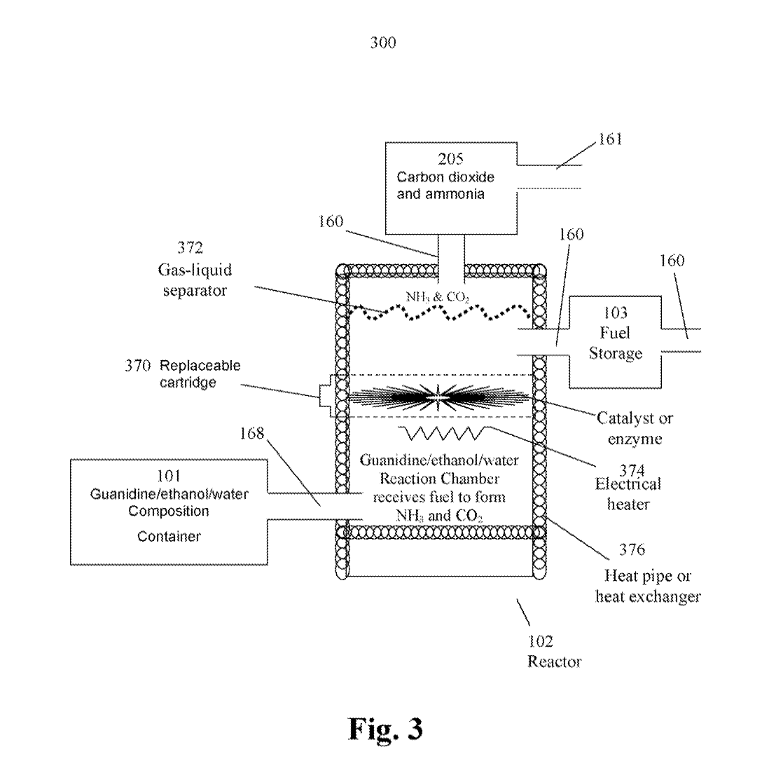

Reactor 102, with reference to FIGS. 1 and 3, may comprise a reaction chamber in which to receive a guanidine-based composition—e.g., from fuel container 101 via delivery means 168. Heat provision may be incorporated into the reactor to be operable for assisting reaction of at least a portion of the reactants within the reactor. For example, in one embodiment, the heat provision may be defined in part by heat exchanger 376, which may be incorporated into walls of the reactor for heat exchange. When the engine is operating, the heat exchanger may be operable to source at least a portion of the heat therefor from thermal energy being produced by the engine. Accordingly, a portion of the exhaust could be routed through the heat exchanger as a source of thermal energy.

In a further embodiment, a thermal relationship may be configured between (i) combustion chamber 104 and (ii) the fluid intake for the reactor chamber and/or perhaps even relative to the walls of the reactor-chamber 102 directly. In yet a further embodiment, a portion of the previously produced product from the reacted composition may be held in reserve and subsequently retrieved and burned for specific purposes of heating the fuel composition in the reactor. For example, during a cold start procedure, the reserved product (such as ammonia or perhaps even hydrogen obtained by cracking) may be retrieved and burned to heat the reactor.

In a further embodiment, reactor 102 may also include an electrical heater element 374 that may be operable to further heat reactants of the fuel composition within the reactor. When additional heat may be needed to heat the composition, electrical energy may be supplied to the heater element. For example, during a cold-start of the engine or furnace, heater element may be activated for heating the guanidine-based fuel composition and facilitate the reaction of guanidine with water. During normal operation, on the other hand, the electrical energy supplied to heat the reactor may be reduced or regulated to sustain a target temperature as may have been predetermined for desired rate of reaction in the reactor and production of product from the reacted composition.

Further referencing FIG. 3, reactor 102 may further comprise means for presenting a catalyst or enzyme therein capable of assisting the reaction of the guanidine with the water therein. In a particular example, the catalyst or enzyme may be provided by a replaceable cartridge 370 containing the catalyst or the enzyme. Accordingly, it may be removed and replaced periodically to supply fresh catalyst or enzyme. In the case of a catalyst, it may be defined for example at least in part by a metal oxide together with barium hydroxide. In a further example, it may comprise barium hydroxide together with an oxide of iron, nickel, vanadium or zinc.

In the case of an enzyme, on the other hand, it may comprise an enzyme capable of facilitating the reaction of guanidine and water. In a particular embodiment, it may comprise arginase and urease. The arginase may catalyze the reaction of guanidine with water to from ammonia and urea; while the urease may facilitate the reaction of urea with water for the formation of ammonia and carbon dioxide. These enzymes may catalyze the reaction at a temperature of between about 0° C. and about 60° C. Such enzyme can be provided in a filter within the tank which may be operable to prevent the enzyme from leaving but be permeable to the gases formed. More typically, however, the enzyme is immobilized on the replaceable cartridge 370 which may be defined at least in part by a substrate of ion exchange resin, ceramic or polymeric materials.

Continuing with further reference to FIGS. 1 and 3, the reactor may further comprise a gas-liquid separator 372 operable to permit ammonia and carbon dioxide product produced from the reacted composition to be separated. Such ammonia and carbon dioxide products may then be collected in gas collection chamber 205 as delivered thereto by way of gas delivery means 160. Further product of the reacted composition may be further collected in fuel storage 103 as delivered thereto via delivery means 160, which is operatively coupled between reactor 102 and fuel storage 103.

The reaction of guanidine therein with water can be described by the following equation (2):

CN₃H₅+2H₂O→3NH₃+CO₂(+96.3kJ/mol) (2)

The reaction and release of energy from guanidine may be accomplished in two steps. In the first step, guanidine reacts with water to from ammonia and urea. The urea may then react with water to form ammonia and carbon dioxide, hi operation, this reaction may be performed at a temperature ranging between about 50° C. and about 240° C. and a pressure ranging between about 1 ambient atmosphere and about 50 standard atmospheres. It may be noted that the first reaction is exothermic while the second reaction is endothermic. The endothermic reaction may take place at a relatively low temperature (˜100° C.), so the heat needed for this step can be obtained from the waste heat that is normally exhausted to the environment from the engine, turbine, or boiler. In some applications, it may be augmented from other sources such as the combustion or oxidization of hydrogen, or perhaps even sourced from a heating element energized by electrical energy such as a battery as may be utilized to assist an initiation of the reaction.

Returning with reference to FIG. 1, the product effected by the reacted composition in reactor 102 may be delivered to the fuel storage 103 by way of the delivery means 160 coupled therebetween. In this example, the product may comprise primarily ammonia, carbon dioxide and ethanol. With operable control from controller 120, the pace of fuel transfer from supply container 101 to reactor 102, and/or reaction caused by reactor 102, and/or the amount of product delivered to fuel storage 103 may be affected by the input parameters received by controller 120—such as known electronic control unit (ECU). As readily available, ECU may include a CPU, ROM, RAM and various input/output ports, memory device storing a variety of types of information which may include a map as known but not shown specifically herein. One input/output port of the controller may be connected to sensor probes such as probe 140, which may be operable to sense a concentration of at least one of the components of the guanidine, ethanol and water fuel concentration. Another I/O port of the controller may be coupled to a user input sensor/transducer 150, which may be operable to receive a user input signal such as an indictor for a desired level of engine performance. In still a further example, another I/O port of controller may be coupled to receive a signal of sensor 130, which may be operable to reflect a level of gas concentration in exhaust produced from the combustion chamber of an internal combustion engine, turbine, boiler or furnace.

In operation according to an embodiment of the invention, the controller 120 may be preconfigured or programmed to be operable to adjust a valve or similar fluid regulator device of delivery means 160 between fuel storage 103 and combustion chamber 104. For example, assuming that the exhaust is determined to contain too much nitrous oxides, the controller in turn may adjust the delivery means to the combustion chamber to provide additional gas thereto for potential excess ammonia so as to allow for the removal of the nitrous oxides by the residual ammonia in the exhaust.

In a further embodiment, the controller may sense a concentration of one of the components of the guanidine, ethanol and water composition in the fuel container 101 and responsive thereto, act to effect recovery of water from the exhaust system by water vapor recovery means (not shown). The recovered water, in turn, may then be recycled to the fuel container 101 or alternatively reactor 102 for purposes of affecting a refinement of the stoichiometric ratios between the guanidine and water portion of the guanidine-based composition. Accordingly, the exhaust resulting from the combustion chamber 104 may be kept within a more acceptable range of ammonia emissions and/or nitrous oxide emission.

In accordance with a particular example, a guanidine-based fuel may be referenced relative to a solution in liking with an E85 type fuel, which may reference a fuel type of 85% ethanol. Generally, the customary ethanol applications required ethanol of nearly 200 proof (100%) purification, so as to prevent possible phase separation of the solution by residual waters therein when it is mixed with the customary hydrocarbon-based liquid fuels. But, such purification processes may be recognized as impacting resulting fuel cost.

It may be understood, however, that purification levels may be more readily obtained at purification levels of 160 to 190 proof. With addition of guanidine and/or urea encapsulated guanidine, the residual water in of the lower proof ethanol may react with the guanidine to form ammonia. The ammonia produced from the addition of the guanidine to the 180-proof ethanol in turn may be completely dissolved at near atmospheric pressure and 25° C. within the remaining ethanol.

In further examples of higher water concentrations, a larger pressure may be employed to dissolve the ammonia within the ethanol, assuming that all of the water is consumed by the reaction with the guanidine. Upon combustion, the ammonia will react with oxygen to yield nitrogen and water with the release of energy. Accordingly, it may be recognized that the added expense associated with the production of the more customary ethanol may be reduced in the absence of the additional steps otherwise required to produce the purified forms of ethanol.

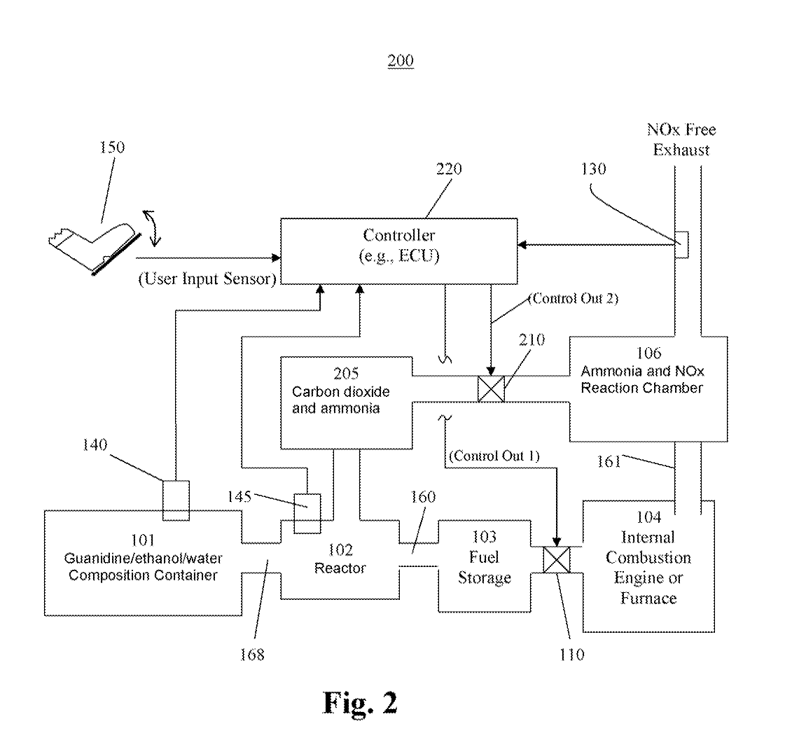

In a further embodiment of the present invention, referencing FIG. 2 with respect to FIG. 1, a gas collection chamber 205 may be used to collect ammonia and carbon dioxide product from the reacted composition from reactor 102. As the reaction of guanidine and water in the reactor produce ammonia and carbon dioxide, the gases may be separated by a gas-liquid separator (for example, separator 372 of FIG. 3) and collected in the gas collector chamber 205. Further delivery means 160 may incorporate pumping means and/or check valves as known to assist collecting the gases from product produced in reactor 102.

In a particular embodiment of operation, controller 220 may sense via sensor 130 nitrous oxide in the exhaust from combustion chamber 106. Responsive to sensing the nitrous oxide, the controller may enable a valve between the gas collection chamber 205 and the path of the exhaust for enable release of a finite amount of ammonia into the exhaust system, such into ammonia and nitrous oxide reaction chamber 106 disposed in the exhaust path from the combustion chamber 104. The added ammonia may serve to react the nitrous oxide with the ammonia to produce nitrogen and water. This water, in turn, may then be recovered if desired for recycling into the reactor.

In a further embodiment, the controller responsive to sensing an increase of nitrous oxide in the exhaust may act to lower the internal operating temperature of the combustion engine, which may serve to lower the nitrous oxide emissions.

For recovery of water from the exhaust, various water recovery embodiments may be used. For example, such water recovery systems may incorporate available water removal membranes, filters, cold traps and/or gas expansion exhaust manifold designs.

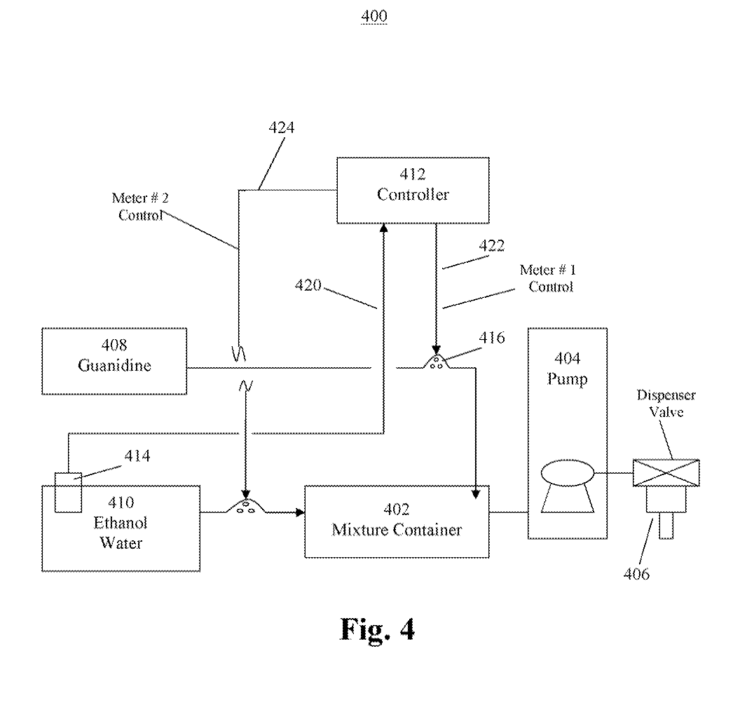

In accordance with a further embodiment of the invention, referencing FIG. 4, a fueling system 400 may comprise a dispenser valve 406 and pump 404 from which to deliver a guanidine based fuel. The pump 404 may be operable to retrieve and pump fuel from container 402 to the dispenser valve 406. The fuel mix may be established according to predefined parameters configured and/or programmed in controller 412. For example, the controller may be operatively configured to sense the concentration of water in an ethanol source 410 by way of sensor 414. Upon determining a concentration of the water, the controller may drive a metering ratio by which to deliver specified amounts of guanidine from guanidine source 408 dependent upon the amounts of the ethanol from ethanol source 410 delivered to mixture container 402. Accordingly, the ethanol and guanidine may be delivered with controlled ratios to mixture container 402 via their respective metering pumps 416, wherein the controlled metering ratios may be based upon the amount of water determined in the ethanol source. In this manner, stoichiometric ratios of guanidine may be established for various mixes of ethanol.

In a particular example, 180 proof ethanol (90% ethanol by volume) may be sensed in the ethanol source. In may be understood therefore a litter of such may comprise 900 mL of ethanol and ˜100 mL H₂O per liter. Stoichioraetricaliy, the 90% ethanol solution with 10% water may be shown with about 90 gm H₂O/(0.9 liter). Complete hydrolysis with guanidine may be calculated as: 90 gm/18 gm= 5.0 moles H₂O for reacting with about 5.0/2=2.5 moles guanidine. This quantity of guanidine may be determined as representative of 2.5*59 gm/mole=147 gm. At a density of 1.32, the volume of the guanidine would be 112 mL, so one could therefore add such amount of guanidine to the ethanol (for ˜11% guanidine by volume) for a stoichiometric mixture.

While certain exemplary features of the embodiments of the invention have been illustrated and described above, it may be understood that various modifications, substitutions, changes and equivalents may now occur to those skilled in the art. It is, therefore, to be understood that the appended claims are intended to cover all such embodiments and changes as fall within the spirit of the invention.

What is claimed is:

1. A method of operating a combustion based energy conversion system comprising:
supplying a guanidine-based composition consisting substantially of water, ethanol and guanidine into a reactor chamber;
reacting guanidine and water of the guanidine-based composition in the reactor chamber to produce ammonia and carbon dioxide which define at least in part portions of product of the reacted composition;
injecting into a combustion chamber of the combustion based energy conversion system at least a portion of the product of the reacted composition;
combusting at least a portion of product of the reacted composition injected into the combustion chamber; and
controlling the injecting of the at least a portion of the product of the reacted composition into the combustion chamber according to at least one attribute of the group consisting of:
a level of power predetermined for desired operation of the combustion based energy conversion system,
a performance parameter of the combustion based energy conversion system determined during operation thereof, and
a concentration determined for at least one of the reactants/products in the reactor chamber and the reactants/products from the combustion chamber.

2. The method of claim 1, in which the reacting comprises heating the composition to accelerate, the reaction of the guanidine with the water.

3. The method of claim 2, in which the heating of the composition is performed at least in part, by use of thermal energy sourced from the combustion based energy conversion system.

4. The method of claim 3, wherein the heating of the composition is assisted at least in part by thermal energy sourced from at least one of (i) a resistive heater that is connected to a battery and (ii) burning of at least a portion of the product of the reacted composition.

5. The method of claim 4, further comprising storing a portion of the product resulting from the reaction of the guanidine-based composition, the stored portion to be available at a subsequent time to assist cold-starting of the combustion based energy conversion system.

6. The method of claim 1, further comprising metering guanidine from a separate reservoir to define at least in part a guanidine portion for the guanidine-based composition supplied dependent on an amount of water determined in the ethanol and the water portions therefor.

7. The method of claim 6, in which the ethanol and the water portions for the guanidine-based composition supplied define an ethanol to water ratio less than about 95% by weight.

8. The method of claim 7, in which the ethanol to the water portions define the ratio to be less than 50% and such that the mixture is essentially non-flammable.

9. The method of claim 6, in which the metering is operable to define at least in part the guanidine portion for the guanidine-based composition supplied for a substantially stoichiometric amount relative to the amount of water determined therein.

10. The method of claim 6, further comprising adding water to define at least in part the water portion of the guanidine-based composition supplied to assist more full reaction of the guanidine portion thereof.

11. The method of claim 10, in which the additional water is sourced from at least one of (i) water recovered from the product of the combustion of the product of the reaction of the guanidine based composition that is exhausted from, the combustion chamber, and (ii) water of an auxiliary tank.

12. The method of claim 1, further comprising compressing at least a portion of the product of the reacted composition to assist the injecting into the combustion chamber.

13. The method of claim 12, further comprising removing a portion of the carbon dioxide (CO₂) from the product of the reacted composition as a part of defining the at least portion of the product of the reacted composition before its injection into the combustion chamber.

14. The method of claim 12, in which the combustion-based energy conversion system includes one of an internal combustion engine, an external combustion engine, or furnace that is defined in part by the combustion chamber, and the combustion is facilitated by igniting a spark in the combustion chamber in presence of the at least portion of product of the reacted composition following its injection into the combustion chamber.

15. The method of claim 12, in which the combustion is facilitated by operatively pressurizing the combustion chamber sufficiently to induce combustion of the at least portion of product of the reacted composition injected therein.

16. The method of claim 1, further comprising treating the reactants/product resulting from the combustion and output as exhaust from the combustion chamber with at least a portion of the products of the reaction of the guanidine-based composition supplied, the treating to reduce the amount of oxides of nitrogen in the exhaust.

17. The method of claim 16, wherein the treating reacts the exhaust with an amount of the products operable to substantially cleanse the exhaust of oxides of nitrogen.

18. The method of claim 1, in which the composition supplied is further defined at least in part by a component selected from the group consisting of:
a combustible fuel, a combustion enhancer, ammonia ammonium bicarbonate, ammonium carbonate, ammonium hydroxide, aminoguanidine, aminoguanidine bicarbonate, aminoguanidine carbonate, aminoguanidine hydroxide, guanylurea, urea coated guanidine, gelling agent, solidifier, oxidizing agent, and denaturing agents; for ethanol.

19. The method of claim 1, in which the guanidine-based composition supplied consists substantially of guanidinium borohydride, ethanol and water; and
the reacting further reacts to form hydrogen and boric acid in addition to the ammonia and carbon dioxide.

20. A method of energy conversion, comprising:
supplying a composition comprising guanidinium borohydride;
reacting the composition with water and forming hydrogen, ammonia, carton dioxide and boric acid; and
oxidizing at least a portion of the ammonia and hydrogen resulting from the reaction and releasing of energy, the oxidizing of the ammonia and the hydrogen forming water and nitrogen.

21. The method of claim 20, in which at least a portion of the water resulting from the oxidizing is recovered and re-introduced for use as water in further said reacting of the composition.

22. The method of claim 20, in which the composition supplied further comprises at least one component selected from the group consisting of a catalyst, free-base quanidine, ammonia, ammonium carbonate, ammonium bicarbonate, guanidine hydroxide, guanidine carbonate, and urea.

23. The method of claim 20, further comprising dissociating at least a portion of the ammonia resulting from the reacting of the composition to form hydrogen and nitrogen.

24. The method of claim 20, in which the reacting of the composition with water uses heating to assist, the reaction, the heat for assisting the reacting soureed at least in part from a portion of the energy released by the oxidizing.

25. A fueling system, comprising:
a mixture container to receive guanidine from a guanidine source and ethanol from an ethanol source;
at least first and second metering devices variably operable by electrical signaling to meter guanidine from the guanidine source and ethanol from the ethanol source to the mixture container;
a controller operable to determine a concentration of the ethanol in the ethanol source and affect at least one of first and second control signals to the respective first and second metering devices for establishing a ratio of guanidine to ethanol delivery to the mixture container dependent on the concentration determined.

26. An engine control system comprising of analysis module operable to analyze the composition of a guanidine/ethanol based fuel that is to power the engine, and a control driver operable to adjust at least one of the engine parameters based on the analysis to affect the efficiency for the fuel burn in the engine.

27. An engine control system comprising of analysis module operable to analyze the composition of a guanidine/ethanol based fuel that is to power the engine, and a control driver operable to add water to adjust the concentration of water in the composition based on the analysis to promote near complete decomposition of guanidine.
